(19) United States
(12) Patent Application Publication
(10) Pub. No.: US 2010/0212132 A1
(43) Pub. Date: Aug. 26, 2010

(54) EXPANDABLE CONNECTOR ASSEMBLY, TOOL ATTACHMENT AND WORKPIECE JIG

(76) Inventor: Richard Alan Walker, Queensland (AU)

Correspondence Address: DAVID A. GUERRA;INTERNATIONAL PATENT GROUP, LLC, Suite 700, 1816 Crowchild Trail N.W., CALGARY, AB, T2M 3Y7, CA

(21) Appl. No.: 11/917,973

(22) PCT Filed: Jul. 6, 2006
(86) PCT No.: PCT/AU06/00957

§ 371 Date: Dec. 18, 2007

(30) Foreign Application Priority Data
Jul. 6, 2005 (AU) 2005903586
Sep. 2, 2005 (AU) 2005904827
Jul. 6, 2006 (AU) PCT/AU2006/000957

(51) Int. Cl. B25B 27/00

(52) U.S. Cl. 29/281.1

(57) ABSTRACT

A kit comprises an expandable connector assembly and a router jig clamp assembly (41) to hold a workpiece comprises a router guide plate (42) having a router tool opening (43), a workpiece guide plate (44) having (45) guides (45 and 46) so that opposite mitres may be cut using the guides (45 and 46). The clamp (41) may be mounted on a bench adjacent a bench router so that upon alignment of a workpiece in position adjacent to opening (43) the press may be used to form the slot in the workpiece. The assembly has a clamp (47) comprising a handle (48), cams (49 and 50), a clamp bar (51) and spring mountings (52) at opposite ends. This enables a workpiece to be clamped when the handle (48) is pulled down to a position running generally parallel to the guide (44). Thus a workpiece is slid along one of the (45) guides into alignment with the slot (43) and then the clamp is applied to hold that piece in position for the slot cutting process. The guide plate (44) is travelling in a guide set at (90) to the plate (42) and consequently the clamp handle (52) for the guide is offset relative to the central guide way for the plate (44).

### FIELD OF THE INVENTION

THIS INVENTION relates to joinery and particularly to joinery employing an expandible connector and more particularly but not limited to joinery employing a kit comprising a tool and connector.

### BACKGROUND TO THE INVENTION

Expandible connectors are known. The connectors are often of plastics and are inserted into a hole and usually employ a rigid expander, often a screw which is driven into the connector to expand the connector into gripping engagement with the hole. Most often the connector is elongate and the expander is driven into the connector in the longitudinal direction of the connector. While this type of connector is useful it has limited application where it is desirable to pull two pieces being joined together. Connectors that apply a force to draw two objects together while connecting are also known. One example is cam connector where a slotted cam is held in a transverse hole, it engages a rod through a side hole and upon rotation of the cam the parts are pulled together.

It is an object of the present invention to provide an expandible connector which is able to draw parts together.

It is a further object to provide an expandable connector insertable into opposed aligned slots where the slots have a narrow entry.

### OUTLINE OF THE INVENTION

In the present case there is provided a kit where the parts of the kit are independently inventive but in the preferred form are matched to each other to provide a matching slotting tool and associated connector. Thus one invention is to a tool, another invention is to a connector and another invention is to a kit comprising a tool and a connector.

Furthermore there is provided a tool for forming a slot for a particular connector and to a method and apparatus for forming the slot and, in particular, but not limited to, a method and apparatus for forming a dovetail slot by routing and an associated expandible dovetail connector.

In one broad aspect therefore there is provided a slot and connector assembly whereby mating slots formed according to the method may be aligned and connected using an expandable connector.

In one preferred form there is provided a slot and connector assembly whereby mating slots formed according may be aligned and connected using an expandable connector, the expandable connector having opposite sections, at least one being an expandable section and the sections being locatable in respective confronting slots of opposed workpieces forming a joint using the connector, the expandable section having an opening to receive an expander and there being an expander forcible into the expandable section, the slots mating to form opposite dovetails, the connector being generally X-shaped in cross section and the expander being generally U-shaped in cross-section with legs insertable into the connector. Preferably, the expandable sections comprise dovetail sections with respective expansion holes.

In addition there is provided a means for placing a workpiece in position so a slot may be formed. The means for placing a workpiece in position may is typically a portable workpiece alignment tool and preferably comprises a jig having a clamp. The jig may be part of the tool. Thus the tool may comprise a jig with an integral router or a jig with a router attachment.

In another broad aspect therefore there is provided a method and apparatus for forming a slot in a workpiece, an expandable connector and an assembly of same, the connector having opposite expandable sections and being locatable in respective confronting slots of opposed workpieces forming a joint using the connector, each expandable section having an opening to receive an expander and there being an expander forcible into the expandable sections, the method comprising positioning the workpiece with respect to a router tool in a portable workpiece alignment tool, and routing a slot to match the expandable sections, the portable alignment tool having a router tool opening and means to position the workpiece in predetermined relation to the router tool while the slot is being formed. Subject to the slot being formed the router tool or the workpiece may be fixed relative to the other.

The particular workpiece alignment tool may have a dedicated router mounted so that the router tool may be moved on a suitable guide means to perform the slot forming operation.

The workpiece alignment tool may have one or more workpiece clamps. It may have one or more workpiece guides. Typically, the alignment tool comprises a guide for forming slots in mitred joints. In addition, it is preferable to include a guide for forming slots for butt joints. In another embodiment the guide is reversible having one position forming slots for mitred joints and another position for forming slots for butt joints. In another embodiment longitudinally extending slots may be formed in an edge of the workpiece by sliding the workpiece along the alignment tool.

The slots may be formed as short transverse slots or may be formed as longitudinally extending slots. In the case of mitred joints, the slots may be formed in workpieces having non-straight or non-flat profiles using an adjustable support. For example, in the case of decorative mouldings, the moulding may be supported by using a slidable wedge to support the non-straight or non-flat portion. The slidable wedge is preferably mounted to travel in a transverse guide way.

The slot is typically a blind slot so that the connector may be inserted into the slot from the rear of the workpieces being joined and consequently the connector is a concealed connector not visible from the front.

In another aspect there is provided an expandable connector having opposite sections, at least one being an expandable section and the sections being locatable in respective confronting slots of opposed workpieces forming a joint using the connector, the expandable section having an opening to receive an expander and there being an expander forcible into the expandable section. Preferably, both sections are expandable and the expander comprises respective expander sections which are simultaneously insertable into both expandable section at once.

The expandable sections preferably comprise dovetail sections so the connector is generally cross or X shaped. The connector preferably has a slot entry end and an opposite flat outer end that may be located just below or flush with the workpiece surface adjacent the slot. The entry end is typically concave. Each expandable section preferably includes an expander locator which is preferably a slot having recessed side walls the expander being locatable in the recess.

The expander is typically U-shaped having legs insertable into the expandable sections. The legs are preferably braced. The expander preferably includes a cap matched to the outer end to cap the outer end.

In a further aspect there is provided a connector assembly comprising a connector and expander as broadly described above and preferably having the preferred features set out above.

In a still further broad aspect there is provided a kit comprising a connector and tool as broadly described above. Typically the tool and connector have the preferred features as set out above.

### BRIEF DESCRIPTION OF THE DRAWINGS

In order that the present invention may be more readily understood and be put into practical effect, reference will now be made to the accompanying drawings and wherein:—

FIGS. 1 and 2 are examples of slotted workpieces adapted to and aligned to receive a connector described below;

FIGS. 3, 4, 5 and 6 are respective elevation, plan, end and underside views of an expandable connector;

FIGS. 7 and 8 are respective side and plan views of an expander for the connector of FIGS. 3 to 6;

FIG. 9 is a side view showing the expander of FIGS. 7 and 8 partially inserted into the connector of FIGS. 3 to 6;

FIGS. 10, 11 and 12 are respective plan and side views of a hand tool for forming a slot of the type illustrated in FIGS. 1 and 2;

FIG. 13 is a perspective view of the tool of FIGS. 10 to 12;

FIG. 14 is a perspective drawing of another embodiment, in this case a clamp (shown in its released position in FIG. 14) for aligning a workpiece for the formation of a slot of the type illustrated in FIGS. 1 and 2;

FIG. 15 is a perspective drawing illustrating the clamp of FIG. 14 with a workpiece clamped in position and the slot having been cut, noting that a 45° guide is employed so that one half of a mitred joint is formed, a second 45° guide is located opposite so a slot may be cut in the opposite mitre;

FIG. 16 illustrates the clamp of FIGS. 14 and 15 with the guide reversed;

FIGS. 17, 18 and 19 are respective plan, side and end views illustrating an alternative embodiment of the clamp; and

FIGS. 20 to 22 are respective side plan and end views of a clamping aid suitable for use with the embodiment of FIGS. 14 to 16.

### METHOD OF PERFORMANCE

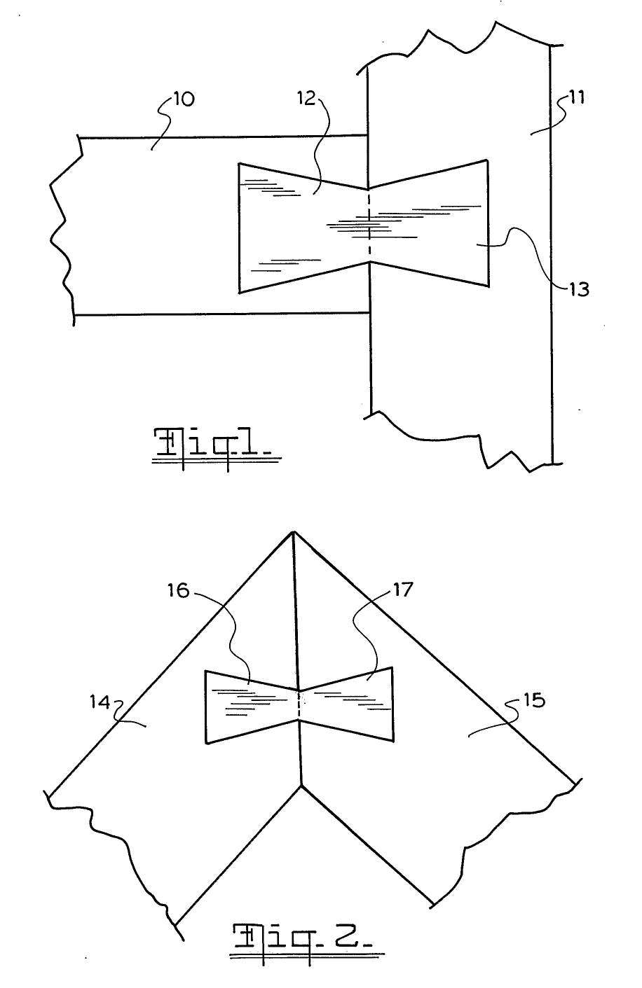

Referring to the drawings and initially to FIGS. 1 and 2, there is illustrated in FIG. 1 workpieces 10 and 11 aligned to form a butt joint whereby the workpiece 10 has a dovetail slot 12 and the workpiece 11 has a dovetail slot 13 which clearly, if filled by a connector, will hold the two parts in the butt joint position.

FIG. 2 illustrates workpieces 14 and 15 forming a mitred joint where slots 16 and 17 are aligned in similar fashion to the slots 12 and 13 of FIG. 1. In order to secure the workpieces of FIGS. 1 and 2 together, an expandable connector is employed and this expandable connector utilises an expander so that when the expandable connector is inserted into the slots and expanded it pulls the two workpieces together and removes any slack in the joint.

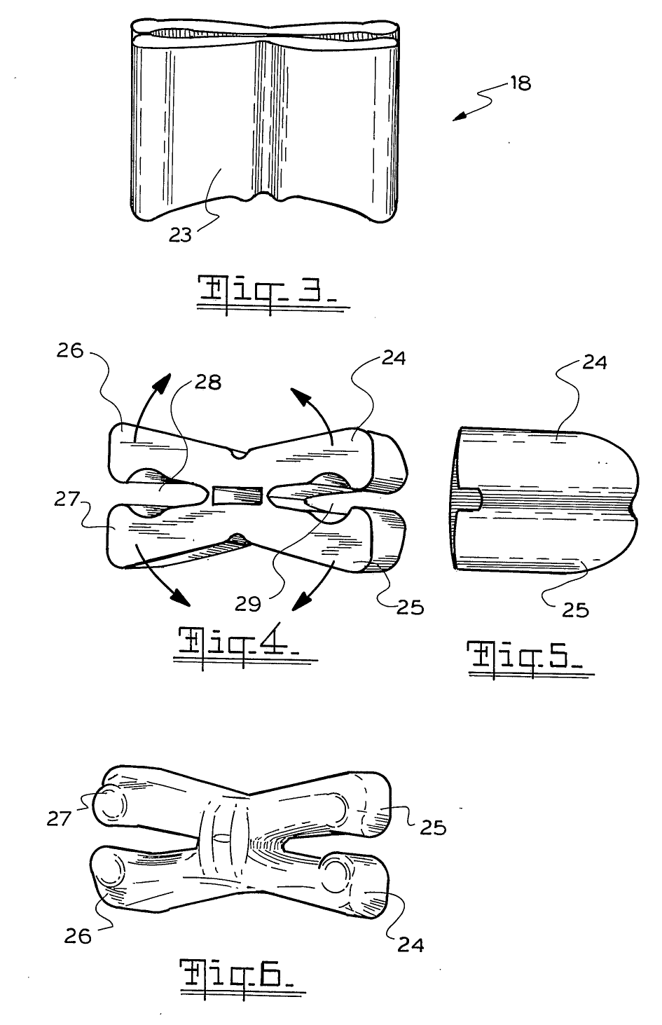

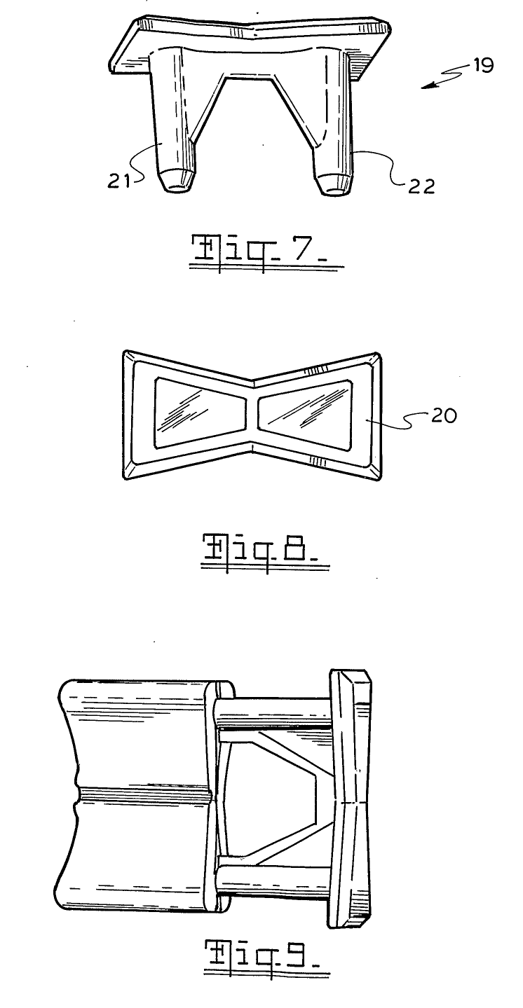

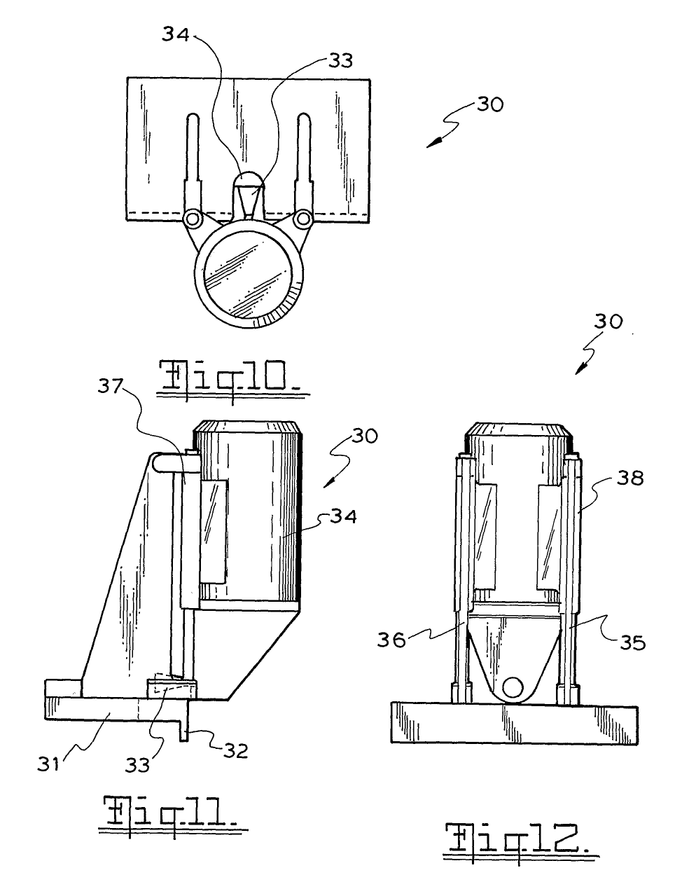

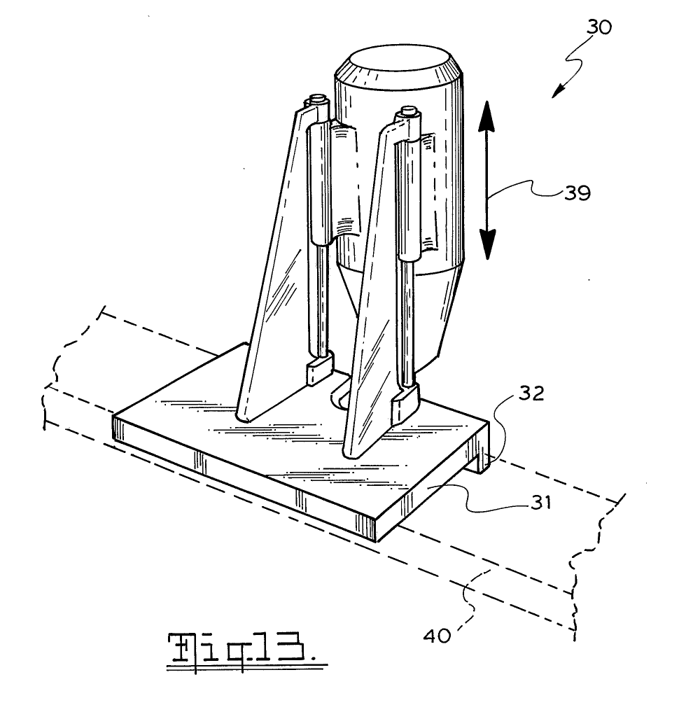

A typical connector is illustrated in FIGS. 3 to 9. Referring to these drawing figures there is illustrated a connector 18 and an expander 19, expander 19 having a capped section 20 and spaced legs 21 and 22 while the connector 18 has an X shaped body 23 comprising wings 24, 25, 26 and 27 whereupon insertion of the expander into apertures 28 and 29 between the respective pairs of wings causes the wings to pivot outward and inward in the direction of the arrows shown thus pulling a joint together.

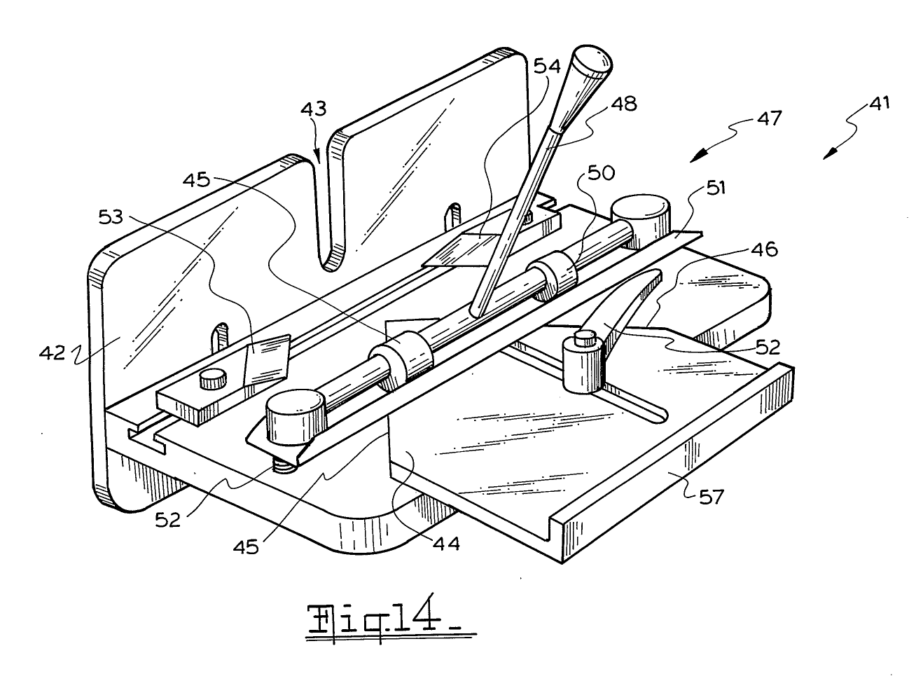

In order to form a slot of the type illustrated in FIGS. 1 and 2 in a workpiece a number of tools are employed and FIGS. 10 to 13 illustrates a hand held tool comprising a workpiece alignment means in the form of plate 31 having a flange 32 such that plate 31 and flange 32 sit at right angles and may be positioned over a corner of workpiece. A router head 33 is adapted to travel through a slot 34 in the plate 31 and cut a slot of the type illustrated in FIGS. 1 and 2 in the aligned workpiece.

The router head is driven by a motor 34 on a carriage formed by guide rails 35 and 36 and guide ways 37 and 38 so that the router head may be moved manually back and forth in the direction as illustrated by arrow 39 in FIG. 13. A workpiece is illustrated in phantom at 40 in FIG. 13. It will be appreciated that by movement of the router motor along the guide and guide ways that a slot according to the present invention would be cut in the workpiece.

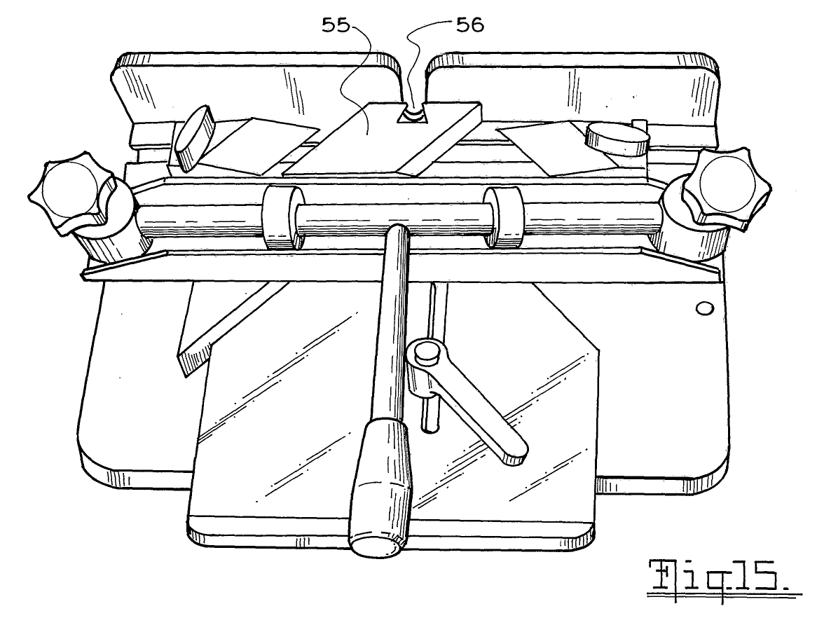

An alternative is illustrated in FIGS. 14, 15 and 16. In this case a greater variety of workpieces may be cut while still being portable, a clamp assembly 41 comprises a router guide plate 42 having a router tool opening 43, a workpiece guide plate 44 having 45° guides 45 and 46 so that opposite mitres may be cut using the guides 45 and 46. The clamp 41 may be mounted on a bench adjacent a bench router so that upon alignment of a workpiece in position adjacent to opening 43 the press may be used to form the slot in the workpiece. The assembly has a clamp 47 comprising a handle 48, cams 49 and 50, a clamp bar 51 and spring mountings 52 at opposite ends. This enables a workpiece to be clamped when the handle 48 is pulled down to a position running generally parallel to the guide 44. Thus a workpiece is slid along one of the 45° guides into alignment with the slot 43 and then the clamp is applied to hold that piece in position for the slot cutting process. The guide plate 44 is travelling in a guide set at 90° to the plate 42 and consequently the clamp handle 52 for the guide is offset relative to the central guide way for the plate 44.

While the clamp and guide may be utilised in relation to rectangular workpieces, in many cases for a mitred joint it is desirable to form a mitred joint in a decorative workpiece and consequently the alignment process for a decorative workpiece in this case involves wedges 53 and 54 which may slide and the wedge may then be used in conjunction with the clamp bar 51 to support the workpiece in its position to cut the slot.

FIG. 15 illustrates a workpiece 55 in position, a slot 56 having been cut using a suitable bench router. As an alternative to a bench router, a router similar to the arrangement illustrated in relation to FIGS. 10 to 13 may be formed on the outside of the plate 42 with suitable guides so that a dedicated router may be used with the clamp arrangement 41 so that there is fixed geometry between the router and the clamp so that the slots may be cut.

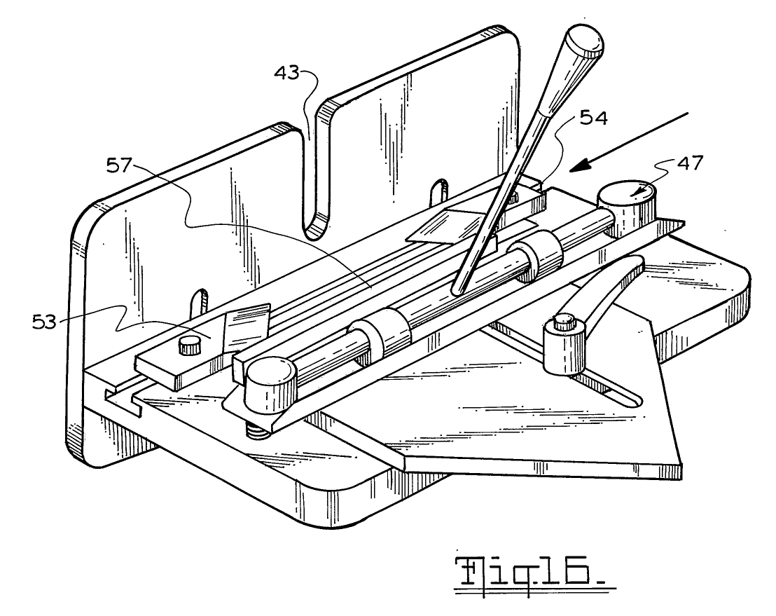

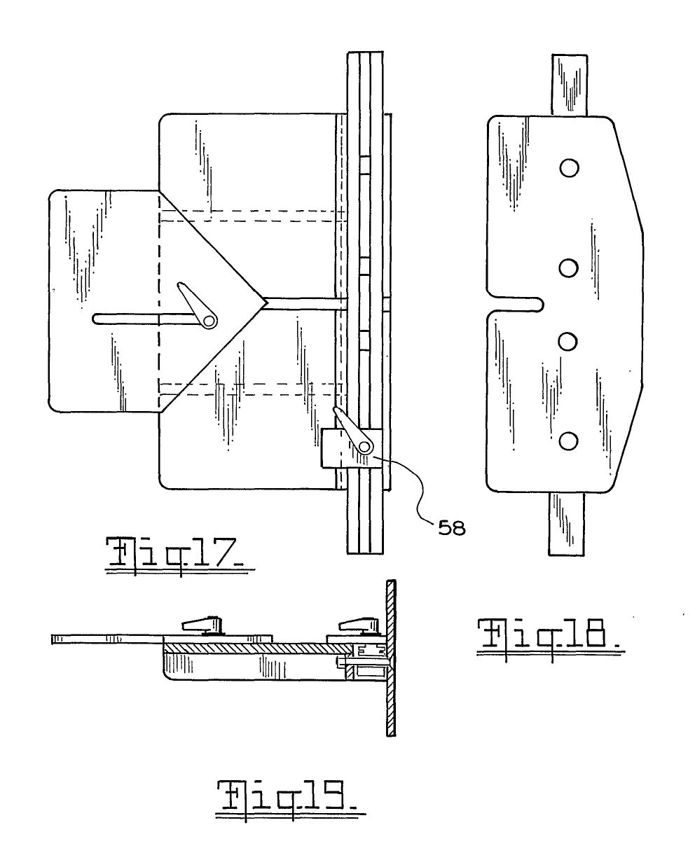

Referring to FIG. 16, it will be clearly seen that the guide plate 44 has been reversed such that its rear edge 57 provides a support for a workpiece slid into the clamp for the purpose of cutting a slot for a joint of the type illustrated in FIG. 1. That is, slot 13 may be cut by removing wedges 53 and 54 and pushing the edge 57 up against the workpiece to secure it relative to the slot 43. In another embodiment, the clamp 47 may be completely removed and the holes utilised for that clamp may be used to secure a holdfast or other clamp to apply downward pressure to a workpiece.

Another embodiment is illustrated in FIG. 17 and as can be seen many of the elements of this embodiment are similar to those of FIGS. 14 to 16. However, the clamp in this case at 58 may be used to clamp either a workpiece in the mitre arrangement or alternatively a workpiece slid in from the left to secure a workpiece for the cutting of a slot suitable for a butt joint. In another case the router tool may be held fixed projecting through the opening 43 and the workpiece slid along to cut a slot.

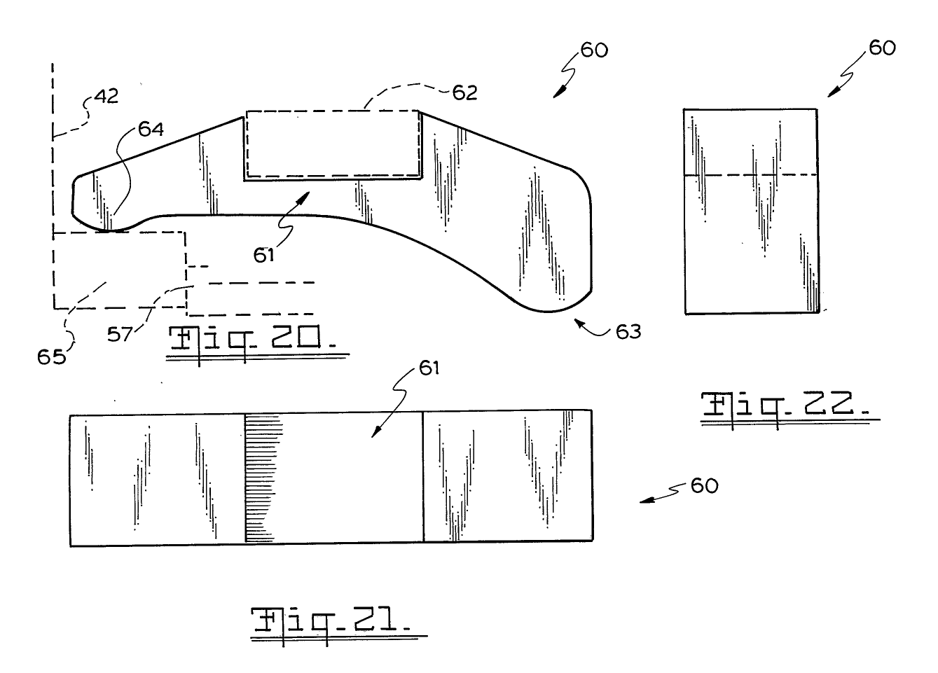

As an alternative to the above described operation of the embodiments of 14 and 15 as described in relation to FIG. 16, a clamping aid according to FIGS. 20 to 22 may be utilised underneath the clamp 47 with the wedges 53 and 54 removed and the guide plate 44 in the reverse configuration of FIG. 16. The clamping aid is used to apply downward pressure on a workpiece running hard up against the plate 42 and parallel to the clamp bar 51. The clamping aid 60 has a recess 61 matching the cross section of the clamp bar 51. The clamp bar 51 is shown in phantom at 62. The clamp aid 60 effectively operates as a lever having a fulcrum at 63 and a clamp head at 64 so that a part operation of the handle 48 the clamping portion 64 applies downward pressure on to a workpiece 65 shown in phantom forcing it down on to the bed of the clamp of FIG. 16 while the plate 57 bears against the workpiece which in turn is held against plate 42, thus the combination of the plate 42, the bed of the apparatus, the plate 47 and the point contact of the clamping head 64 secures the workpiece 65 in place, such that a slot may be cut in a workpiece 65 held in this position. It will be appreciated that a slot may be cut transversely in the workpiece 65, or the workpiece 65 may be slid with sufficient clamping force to enable close sliding so that a longitudinal slot may be cut.

Whilst the above has been given by way of illustrative example of the present invention many variations and modifications thereto will be apparent to those skilled in the art without departing from the broad ambit and scope of the invention as set out in the appended claims.

1-45. (canceled)

46. A workpiece joinery system for holding and joining workpieces featuring at least one slot, said workpiece joinery system comprising:
a jig clamp assembly for holding a workpiece, said jig clamp assembly having a router guide plate defining a router tool opening, a workpiece guide plate including guides, and a clamp; and
an expandable connector for aligning and connecting mating slots of opposed workpieces formed in by said jig clamp assembly, said expandable connector having opposite sections, at least one of which being an expandable section, said sections being locatable in respective confronting slots of opposed workpieces forming a joint using said expandable connector, said expandable section defining an opening to receive an expander;
wherein the workpiece is removably clamped in position adjacent said router tool opening when said handle is pulled down to a position running generally parallel to said workpiece guide plate.

47. The workpiece joinery system according to claim 46, wherein said expandable connector being generally X-shaped in cross section and said expander being generally U-shaped in cross-section with legs insertable into said expandable connector.

48. The workpiece joinery system according to claim 46, wherein said opposite sections of said expandable connector are each expandable, and said expander comprises respective expander sections which are simultaneously insertable into both expandable sections at once.

49. The workpiece joinery system according to claim 46, wherein said expandable sections comprise dovetail sections with respective expansion holes, and the slots mating to form opposite dovetails.

50. The workpiece joinery system according to claim 46, wherein said expandable connector has a slot entry end and an opposite flat outer end located adjacent a workpiece surface adjacent said slot.

52. The workpiece joinery system according to claim 46, wherein the connector has a concave slot entry end.

53. The workpiece joinery system according to claim 46, wherein said expandable section includes an expander locator comprising an expansion slot having side walls with opposed recesses, said expander being locatable between said recesses.

54. The workpiece joinery system according to claim 46, wherein said expandable connector includes an outer end, and said expander includes a cap matched to said outer end to cap said outer end.

55. The workpiece joinery system according to claim 46, wherein said workpiece guide plate being adapted to attach a router tool thereto so that said router tool may be moved on said guide to perform a slot forming operation on said workpiece.

56. The workpiece joinery system according to claim 46, wherein said jig clamp assembly further comprising at least one slidable wedge mounted to travel in a transverse guide way located between said router guide plate and said workpiece guide plate.

57. The workpiece joinery system according to claim 46, wherein said guide being reversible having one position for forming slots for mitered joints and another position for forming slots for butt joints.

58. The workpiece joinery system according to claim 46, wherein said jig clamp assembly further comprising an adjustable support for forming slots in workpieces having non-straight profiles.

59. A workpiece joinery system comprising:
a jig clamp assembly for holding a workpiece, said jig clamp assembly having a router guide plate defining a router tool opening, a workpiece guide plate including guides, and a clamp, said clamp including a handle, at least one cam, a clamp bar, and spring mounting at opposite ends, said workpiece guide plate travels in a guide set at 90° to said router guide plate;
an expandable connector for aligning and connecting mating slots of opposed workpieces formed in by said jig clamp assembly, said expandable connector having opposite sections, at least one of which being an expandable section, said sections being locatable in respective confronting slots of opposed workpieces forming a joint using said expandable connector, said expandable section defining an opening; and
an expander receivable in said opening of said expandable section of said expandable connector;
wherein said expandable connector being generally X-shaped in cross section and said expander being generally U-shaped in cross-section with legs insertable into said expandable connector;
wherein the workpiece is removably clamped in position adjacent said router tool opening when said handle is pulled down to a position running generally parallel to said workpiece guide plate.

60. The workpiece joinery system according to claim 59, wherein said opposite sections of said expandable connector are each expandable, and said expander comprises respective expander sections which are simultaneously insertable into both expandable sections at once.

61. The workpiece joinery system according to claim 59, wherein said expandable sections comprise dovetail sections with respective expansion holes, and the slots mating to form opposite dovetails.

62. The workpiece joinery system according to claim 59, wherein said expandable connector has a slot entry end and an opposite flat outer end located adjacent a workpiece surface adjacent said slot.

63. The workpiece joinery system according to claim 59, wherein said expandable section includes an expander locator comprising an expansion slot having side walls with opposed recesses, said expander being locatable between said recesses.

64. The workpiece joinery system according to claim 59, wherein said jig clamp assembly further comprising at least one slidable wedge mounted to travel in a transverse guide way located between said router guide plate and said workpiece guide plate.

65. A method of using a workpiece joinery system, said method comprising the steps of:
(a) providing a workpiece joinery system comprising: a jig clamp assembly for holding a workpiece, said jig clamp assembly having a router guide plate defining a router tool opening, a workpiece guide plate including guides, and a clamp; and an expandable connector for aligning and connecting mating slots of opposed workpieces formed in by said jig clamp assembly, said expandable connector having opposite sections, at least one of which being an expandable section, said sections being locatable in respective confronting slots of opposed workpieces forming a joint using said expandable connector, said expandable section defining an opening to receive an expander; wherein the workpiece is removably clamped in position adjacent said router tool opening when said handle is pulled down to a position running generally parallel to said workpiece guide plate;
(b) positioning a workpiece with respect to a router tool in said workpiece guide plate so that the area of said workpiece which is indented to have the slot is adjacent said router tool opening of said router guide plate;
(c) clamping said workpiece in position against said router guide plate using said clamp;
(d) routing a slot in said workpiece using the router tool, said slot being routed to match the outer shape of said expandable section of said expandable connector;
(e) inserting said expandable section of said expandable connector in the slot; and
(f) inserting said expander in said opening defined in said expandable section of said expandable connector.
